(19) United States
(12) Patent Application Publication
(10) Pub. No.: US 2002/0071109 A1
(43) Pub. Date: Jun. 13, 2002

(54) Laser radar system and method

(76) Inventors: Christopher Allen, Independence, MO (US); Sivaprasad Gogineni, Lawrence, KS (US)

Correspondence Address: James M. Stipek, Lathrop & Gage, LC, Suite 2800, 2345 Grand Boulevard, Kansas City, MO, 64108, US

(21) Appl. No.: 09/912,729

(22) Filed: Jul. 24, 2001

Related U.S. Application Data
(60) Provisional application No. 60/220,455, filed on Jul. 24, 2000.

(51) Int. Cl. G01C 3/08

(52) U.S. Cl. 356/5.01

(57) ABSTRACT

A laser radar system and method use a reference signal that is impressed on an optical carrier for transmission as a transmit signal. When the transmit signal is reflected or otherwise scattered by a target and returned to the laser radar system as a receive signal, the receive signal is received and processed to remove the optical carrier component of the receive signal to result in a radio frequency (RF) carrier signal. The RF carrier signal is processed to obtain an RF envelope. The RF envelope is processed with the reference signal to determine a difference frequency between the reference signal and the RF envelope. The resultant difference frequency is proportional to the delay period between the time the transmit signal was generated and the receive signal was received. By using the difference frequency, and thereby using the delay, the range between the laser radar system and the target can be determined.

### RELATED APPLICATIONS

The present application claims the benefit of U.S. provisional application Serial No. 60/220,455 entitled Coherent Laser Radar Having RF Pulse Compression.

### FEDERALLY SPONSORED RESEARCH OR DEVELOPMENT

The U.S. Government has certain rights in this invention as provided for by the terms of Contract/Grant No. NASI-99052 awarded by the National Aeronautics and Space Administration.

### FIELD OF THE INVENTION

The present invention relates to laser radar systems.

### BACKGROUND OF THE INVENTION

Laser radar systems have been used for a variety of applications and methods, including for measuring ice sheet surface elevation and vegetation heights from satellites. These laser radar systems typically require smaller lens apertures than comparable microwave radars and can more precisely measure ranges than microwave radars.

Many of the laser radar systems currently in use short duration, high peak power pulses for their transmitted signals. Also, these systems typically operate with a low pulse repetition frequency (PRF). The high peak power operation results in a limited lifetime for the onboard lasers, and the low PRF provides sparse spatial samples for data reception and measurement. Moreover, the high peak power operation requires significant power usage for the lasers. In addition, selection of the wavelengths for many lasers results in the generated signal being absorbed by ice.

Thus, a system and method are needed that will reduce peak power requirements and increase pulse repetition frequencies of the laser radars' generated optical signals to obtain a more dense sampling of data received when trying to determine the property of an object, such as the range to an object. A more efficient and effective system and method are needed to generate, receive, and process optical signals for orbital, land based, and aquatic applications.

### SUMMARY OF THE INVENTION

The present invention is directed to a system and method for determining a range to an object using laser radar. The system comprises a controller configured to generate a first reference signal. The system further comprises a transmitter configured to generate an optical carrier, to use the first reference signal to amplitude modulate the optical carrier to create a transmit signal, and to generate an optical local oscillator signal. Optics are configured to transmit the transmit signal and to receive a receive signal. The receive signal is at least a portion of the transmit signal scattered back to the receiver. The system also comprises a receiver configured to receive the receive signal and to process the receive signal with the optical local oscillator signal to generate an RF envelope. The controller further is configured to process the RF envelope with a second reference signal to determine a difference frequency between the RF envelope and the second reference signal. The range is a function of the difference frequency and may be determined, for example, by using a frequency/range equation.

### BRIEF DESCRIPTION OF THE DRAWINGS

FIG. 1 is a block diagram of a laser radar system in accordance with an embodiment of the present invention.

FIG. 2 is an expanded block diagram of a laser radar system in accordance with an embodiment of the present invention.

FIG. 3 is an expanded block diagram of another laser radar system in accordance with an embodiment of the present invention.

FIG. 4 is an expanded block diagram of another laser radar system in accordance with an embodiment of the present invention.

FIG. 5 is an expanded block diagram of another laser radar system in accordance with an embodiment of the present invention.

FIG. 6 is an expanded block diagram of another laser radar system in accordance with an embodiment of the present invention.

### DETAILED DESCRIPTION OF THE PREFERRED EMBODIMENTS

The system and method of the present invention incorporate fiber optic technologies with radio frequency (RF) and signal processing techniques to produce a very sensitive laser radar system with fine range accuracy. The present invention impresses an RF signal on an optical carrier for transmission and reception through optics. The receive signal is filtered and detected to recover the RF portion of the signal. The RF receiver operates as a matched filter to extract the RF portion from noise. The recovered RF portion is digitized and averaged to further improve the signal-to-noise ratio (SNR).

The present invention uses a reference signal to generate a transmit signal having an RF component on an optical carrier. At least a portion of the transmit signal is reflected or otherwise scattered by a target, such as a landmass, ice, a manmade object, an object under a body of water, or another target. The reflected or otherwise scattered portion of the transmit signal returns to the laser radar system as a receive signal. The RF component of the receive signal is recovered and applied against the same reference signal to determine a change in the frequency between the transmit signal and the receive signal. The range between the laser radar system and the target is a function of that frequency. Therefore, the range can be determined by determining that frequency.

The present invention generates a transmit signal having lower power than prior systems. For example, some prior systems generated signals using 15 megawatts (MWs) of power. Whereas, in one embodiment, the present invention uses only one watt of power to generate the transmit signal. Thus, a significant power savings occurs. Since a lower power is required, lasers used in the system have a greatly extended lifetime. Thus, the present invention may use fewer lasers than prior systems. Since the present invention requires a smaller power supply and fewer components, a significant cost savings in componentry is achieved while greatly reducing the weight of the overall system. In addition, the lower power and fewer components result in a safer overall system.

The present invention uses a longer pulse duration than the prior systems while increasing the pulse generation rate over prior systems. For example, a prior system may generate 40 pulses per second using a 4 nano second (ns) pulse duration. Thus, the return data rate is relatively poor. The present invention, in one embodiment, may be configured to generate 4000 pulses or more per second, using a pulse duration of 40 microseconds (us). Thus, the present invention has a greater data rate return for transmit and receive signals, thereby resulting in a greater sampling of signals and more complete data.

The present invention may be used in a variety of systems for a variety of uses. For example, the present invention may be used in an orbital satellite for range determination operations. The wavelength of a laser radar system can be selected to improve the sensitivity of the system to snow and ice while continuing to exploit commercially available fiber optic components. For example, one embodiment may be configured to generate a transmit signal at a 1310 nanometer (nm) wavelength. Although, other wavelengths may be used.

In addition, the present invention may be used in other embodiments. For example, the present invention may be used in a submersible, such as a torpedo or a submarine, to determine a range to an underwater target, such as a landmass or object. Because the present invention uses an optical carrier, and because the electromagnetic properties of the optical carrier readily can travel through water, the laser radar system is operable and efficient under water as well as above ground.

Prior systems, such as microwave systems were not operable in salt water and other water conditions. Moreover, acoustic-type range finders are not readily reliable or desirable in all instances. For example, acoustics may be blocked or dispersed by layers of water having different temperatures. Moreover, the optical carrier of the present invention has a lower probability of interception than otherwise would be valid for an acoustic system. For example, signals generated by sonar systems may be intercepted and may identify the presence of the system generating the sonar signal. Whereas, the specific frequency of the transmit signal would have to be known to have knowledge of and intercept the optical carrier of the transmit signal.

It will be appreciated that the present invention may be used in any laser range finding device or laser radar system. For example, the present invention may be used with surveillance equipment or other devices in which range finding using laser radar systems can be used.

The present invention may be configured to generate one or more transmit signals and receive one or more receive signals simultaneously, near simultaneously, or consecutively. This configuration further increases the sampling rate for transmit-to-receive target acquisition and range determination.

Moreover, the present invention may be configured to generate one or more reference signals to be impressed on the transmit signal and used to recover the frequency for the receive signal. Thus, a first reference signal can be used for determination of a first range, and a second reference signal can be used for determination of a second range. Therefore, the present invention may be configured to simultaneously be sensitive to either one range or multiple ranges. Moreover, since system parameters may be configurable, potential ranges may be selectable, or one or multiple ranges may be preset.

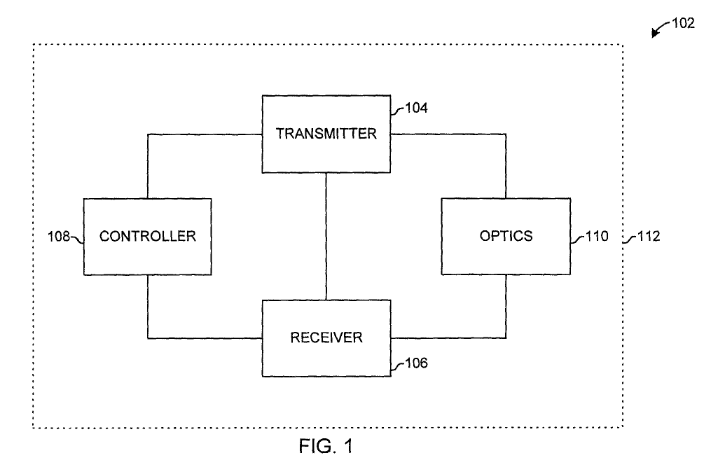

FIG. 1 depicts an exemplary embodiment of a laser radar system of the present invention. The laser radar system 102 of FIG. 1 comprises a transmitter 104, a receiver 106, a controller 108, and optics 110. The laser radar system 102 may reside on an application device 112.

The transmitter 104 generates the optical carrier to be generated by the optics 110. The transmitter 104 may be configured to generate the optical carrier using a laser, such as a laser configured to generate a 1310 nm or 1319 nm optical carrier. The optical carrier also is transmitted from the transmitter 104 to the receiver 106 for use as an optical local oscillator (LO). The transmitter 104 receives the reference signal from the controller 108 and impresses the reference signal on the optical carrier. The transmitter 104 may be configured to modulate or amplify the optical carrier, such as with intensity modulation or frequency modulation. For example, the reference signal may be used to drive the modulation.

The receiver 106 receives the receive signal from the optics 110 and processes the receive signal with an optical LO signal and the reference signal to determine the frequency of the receive signal. The receive signal is time delayed, meaning that there is a time delay between the time the transmit signal is transmitted and when the receive signal is received. Any resultant frequency shift that relates to the range to a target comes from the fact that the reference signal has a frequency verses time slope (i.e. a chirp rate) that translates time delays into frequency.

In some embodiments, the receiver 106 may comprise a frequency shifter configured to receive the optical carrier signal from the transmitter 106, frequency shift the optical carrier to create an optical LO, apply the optical LO to the receive signal to generate an envelope of the receive signal to be transmitted to the controller 104. The envelope comprises the RF component of the receive signal, including the intensity/amplitude modulated reference signal portion time delayed between transmitting the transmit signal and receiving the portion of the scattered transmit signal as a receive signal.

The controller 108 may be configured to generate the reference signal in the form of a waveform, such as a sinusoidal waveform having a frequency. The controller 108 determines the parameters of the reference signal and generates the reference signal to the transmitter 106. Preferably, the controller 108 generates a chirp signal having a bandwidth of 260 megahertz (MHz) as the reference signal. Although, other waveforms having other frequencies and other signals may be used. The controller 108 may be configured to enable modifying reference signal parameters, such as waveform parameters including a frequency of the reference signal, a pulse duration of the reference signal, a chirp rate of the reference signal, a clock rate at which the reference signal is generated, and/or other parameters.

The controller 108 also processes the receive signal received from the receiver 108. The controller 108 receives the processed receive signal from the receiver 108, applies the reference signal to the receive signal, and determines the frequency difference between the transmit signal and the receive signal. Since the difference frequency is a function of the range between the laser radar system 102 and a target (i.e. the time delay between transmitting and receiving a signal), and the range is a proportional function of frequency, the controller 108 uses the frequency to determine the range to the target. Thus, the frequency of the receive signal is a function of the delay between generating the transmit signal, the transmit signal traveling to a target and at least a portion returning back as the receive signal, and receiving the receive signal. Because the reference signal is impressed on the transmit signal, and because that reference signal therefore is received with a time delay as part of the receive signal, the difference in the frequencies of the transmit signal having the impressed reference signal and the receive signal from which the reference signal is retrieved.

In one embodiment, the difference in the frequencies is proportional to the time delay between transmitting the transmit signal and receiving the receive signal according to the following equation: f=(2BR)/(ct). In this equation, “f” is equal to the frequency of the receive signal after it is applied to a frequency shifted optical local oscillator and subsequently dechirped and filtered. “B” is equal to the bandwidth of the reference signal, where the bandwidth is the range of frequencies over which transmit signals are generated. “R” is equal to the range to the target, “c” is equal to the speed of light, and “t” is equal to the duration of the transmit pulse. Thus, the range to the target can be determined when the frequency of the time delayed reference signal is determined.

The controller 108 may be configured with a processor, such as a digital signal processor (DSP), having settable parameters. Thus, the controller 108 may be configured to receive instructions identifying processing parameters, such as the number of samples to collect when digitizing an analog signal, an identity of an averaging method, or an identity of a number of averages to be used to process a receive signal. Further, the controller 108 may be configured to output data to an output device, such as a monitor, a printer, digital media, optical media, or other media. In some embodiments, the controller 108 may comprise a monitor, media, and/or other input and/or output devices.

The controller 108 may be configured with various filters and/or converters if needed in particular embodiments. For example, in some embodiments, the controller 108 may include a low pass filter, a band pass filter, or other filters or converters.

The optics 110 couples single mode optic fiber into free space. The optics 110 may comprise an astronomical telescope, such as those using mirrors. Such telescopes usually have an “f” number of the telescope matching the “f” number of the optic fiber for good efficiency. The “f” number is the ratio of the diopter of the optics to the focal length of the optics.

It will be appreciated that the optics 110 in each of the embodiments may comprise one or more sets of optics. For example, any of the laser radar systems may have one optic for the transmit signal and one optic for the received signal. Additionally, the optics 110 may use a circulator such that the optic fibers for the transmit signal and the receive signal connect to a circulator, and a single optic fiber leads between the circulator and the optics 110. Other configurations exist.

The application device 112 is any device on or in which the laser radar system 102 resides. The application device 112 may be a satellite, a submarine, torpedo, or other submersible, a land based system, a surveillance device, or any other device configured to use laser radar. Optical fiber may be used to carry a laser generated signal from the transmitter 104 to the receiver 106 in some embodiments. The optical fiber may comprise single mode fiber. Optical fiber carriers the optical carrier from the transmitter 104 to the optics 110 for transmission and from the optics 110 to the receiver 106 for reception. Multiple optical fibers may be connected between the transmitter 104 and the optics 110, between the optics and the receiver 108, and between the transmitter and the receiver. Alternately, a single fiber may be connected between each of those components. When multiple optic fibers are connected between the transmitter 106 and the optics 110 or between the optics and the receiver 108, multiple transmit signals can be generated to be transmitted from the optics, and multiple receive signals can be received at the optics and transmitted to the receiver.

The laser radar system 102 transmits a long duration pulse having low power to obtain the same performance as a short duration pulse having high power. This is achieved by encoding the transmit pulse with a predetermined waveform, such as the reference signal, and processing a receive signal with a matched filtering process to determine correlation between the transmit signal and the receive signal. The transmit signal can be encoded by using intensity/amplitude modulation of the optical carrier used for the transmit signal. In this instance, the optical carrier may be a laser signal.

The intensity modulation may be accomplished using an external modulator separate from a laser or an internal modulator built into the laser. Due to developments in laser systems, many laser components are commercially available and operate within an RF bandwidth.

In one example, an external modulator is configured to split the optical carrier into a reference channel and phase modulated channel, change the phase (phase modulate) of the optical carrier in the phase modulated branch, and sum the reference channel with the phase modulated channel. Thus, the intensity modulation may operate consistent with an interferometer. On the receiving end, a matched filtering process in the receiver 106 processes the receive signal to determine the RF envelope and mixes the RF envelope to produce a correlated signal having the difference between the frequency of the transmit signal and the time delayed frequency of the receive signal.

The laser radar system 102 of FIG. 1 operates as follows. The controller 108 generates a reference signal to the transmitter 106. In this example, the reference signal is a chirp signal having a starting frequency of 100 MHz and a bandwidth of 260 MHz. The transmitter 104 generates an optical carrier and impresses the reference signal on the optical carrier using intensity modulation. The transmitter 104 transmits the optical carrier with the impressed reference signal to the optics 110 as the transmit signal. The optics 110 transmits the transmit signal.

The transmit signal is transmitted to a target, and at least a portion of the transmit signal is scattered and received back at the optics 110 as the receive signal. There is a delay time between transmitting the transmit signal and receiving the receive signal.

The optics 110 transmits the receive signal to the receiver 108. The receiver 106 also receives the optical carrier from the transmitter for use as the optical LO signal with a frequency shift. The receiver 106 processes the receive signal with the optical LO signal to generate the RF envelope. The controller 108 transmits the RF envelope to the controller 104.

The controller 108 receives the RF envelope and processes it with the reference signal to generate a correlated signal having a frequency difference between the transmit signal and the receive signal. The controller 108 processes the identified frequency with the above referenced range/frequency formula to determine the range to the target. The controller 108 outputs the identified range to an output device.

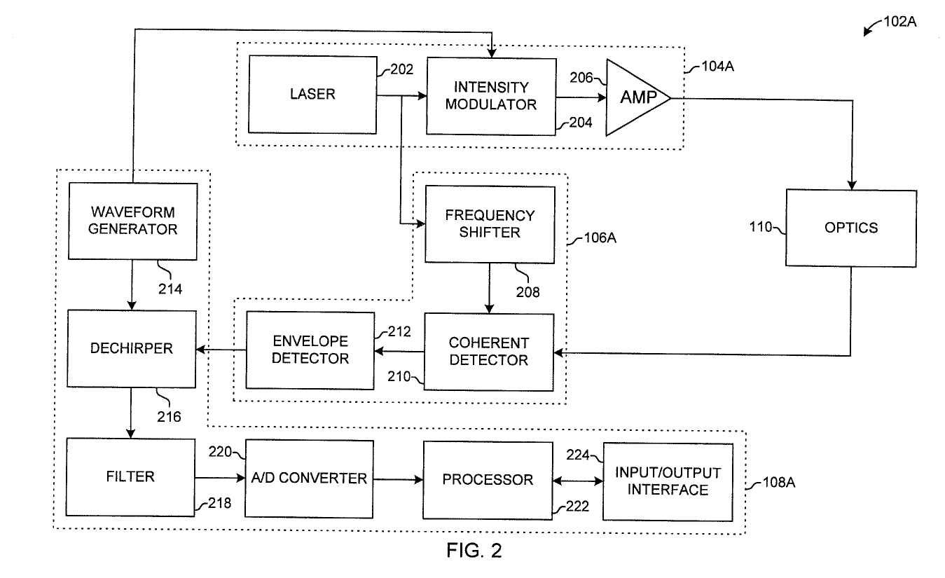

FIG. 2 depicts an exemplary embodiment of a laser radar system 102A of the present invention. The laser radar system 102A of FIG. 2 depicts embodiments of the transmitter 104A, the receiver 106A, and the controller 108A. The optics 110 are the same as the optics of FIG. 1.

The transmitter 104A generates the transmit signal to be transmitted from the optics 110. The transmitter 104A also generates the local oscillator signal used by the receiver 106A. The transmitter 104A of FIG. 2 comprises a laser 202, an intensity modulator 204, and an amplifier 206.

The laser 202 generates a base signal used as the optical carrier for the transmit signal and as a local oscillator signal. In other embodiments, the laser 202 may not generate a signal to be used as a local oscillator signal. Preferably, the laser 202 generates a single frequency, stable base signal. In some embodiments, the laser 202 generates a base signal at 1310 mn or 1319 nm. However, other wavelengths may be used. The laser 202 is coupled to fiber leaving to the intensity modulator 204 and the transmitter 104A. In some embodiments, the fiber between the laser 202 and the intensity modulator 204, and between other components, may need to be polarization maintaining fiber.

The intensity modulator 204 modulates the intensity of the optical carrier. The intensity modulator 204 impresses the reference signal onto the optical carrier by using the reference signal as the driver to control how the optical carrier is amplitude/intensity modulated. The intensity modulator 204 may operate as an interferometer as discussed above.

Multiple types of intensity modulators may be used. For example, the intensity modulator 204 may comprise an electro-optic modulator, such as a Mach-Zehnder Modulator (MZM), an acousto-optic modulator, an electro-absorption modulator, and/or a polarization insensitive modulator.

The MZM uses electro-optic effects to phase change a phase modulated channel and sum it with a reference channel to create intensity modulation. MZM uses voltage changes to induce optical intensity modulation.

The acousto-optic modulator generates high frequency signals (compression waves) to bend/reflect the light of the optical carrier. The acousto-optic modulator has a side effect of a frequency shift/doppler shift.

The electro-absorption modulator has a semiconductor material that absorbs photons. The absorption is controlled by controlling voltage applied to electro-absorption modulator. The absorption changes the attenuation of the light, so that changing the voltage extinguishes light.

The polarization insensitive modulator uses a 2×2 coupler and a voltage controlled phase modulator to modulate the optical carrier. The intensity modulator 204 uses the reference signal as the drive signal to modulate the intensity of the optical carrier.

It will be appreciated that the intensity modulator 204 may be selected based on modulation properties, including bandwidth, polarization sensitivity, linearity, and efficiency. Other modulators may be used.

The amplifier 206 is optional. The amplifier 206, when needed, is used to amplify the power of the optical carrier. If the power level is sufficient upon leaving the intensity modulator 204, the amplifier is not needed. A fiber amplifier or a semiconductor amplifier may be used. Other amplifiers may be used.

The receiver 106A receives the receive signal from the optics 110 and the local oscillator signal from the laser 202. The receiver 106A processes the receive signal with the local oscillator signal to generate the RF envelope. The RF envelope consists of the reference signal waveform. The transmitter 104A of FIG. 2 comprises a frequency shifter 208, a coherent detector 210, and an envelope detector 212.

The frequency shifter 208 shifts the frequency of the optical local oscillator signal. Since the laser radar system 102A of FIG. 2 uses a heterodyne design, the frequency shifter 208 is used to create a difference between the frequencies of the optical carrier that will be received in the receive signal and the frequency of the local oscillator signal.

In a heterodyne design, two optical signals are processed at a coherent detector to determine the difference between the respective frequencies of the two optical signals. In other embodiments, a homodyne design may be used. In the homodyne design, two optical signals having the same frequency are processed. In a homodyne design, a frequency shifter is not needed.

The frequency shifter 208 shifts the frequency of the local oscillator signal by a configurable amount. The frequency shift must be higher than the greatest envelope frequency. In one embodiment, the frequency shifter 208 shifts the frequency of the local oscillator signal by 600 MHz. The frequency shifter 208 may comprise an acousto-optic frequency shifter, an MZM with an optic filter, an MZM configured as a single sideband modulator with carrier suppression, or other frequency shifters.

The coherent detector 210 receives the local oscillator signal and the receive signal, mixes the two signals, and determines the difference in the frequency of the two signals. The difference in the frequencies between the local oscillator signal and the receive signal is the RF carrier frequency. In one embodiment, the resultant RF carrier frequency is a 600 MHz sinusoid that is intensity modulated by the reference signal.

The coherent detector 210 may be a mixer, a photo diode, another diode, a photo detector, or another coherent detector that generates the difference of frequencies of two optical signals. The coherent detector 210 changes the frequency of the carrier from optical to RF only. It does not change the frequency of the RF envelope of the RF carrier.

The envelope detector 212 receives the RF carrier from the coherent detector 210. The envelope detector 212 recovers the RF envelope from the RF carrier. Thus, where the RF carrier is a 600 MHz sinusoid that is intensity modulated by a reference signal, the envelope detector 212 recovers an RF envelope comprising the reference signal.

The envelope detector 212 may comprise a rectifying system or circuit. The envelope detector 212 may comprise, for example, a Schottky barrier diode or a mixer. If a mixer is used, the RF carrier signal is split and used to drive both ports. Alternately, if a mixer is used, the RF carrier is input to one terminal, and the unused terminal is shorted.

The controller 108A generates the reference signals to be used by the transmitter 104A and by the controller to determine the frequency difference between the transmit signal and the receive signal. Further, the controller 108A filters and converts the frequency difference (i.e. the correlated signal) so that the range may be determined. The controller 108A of FIG. 2 comprises a waveform generator 214, a dechirper 216, a filter 218, an analog to digital (A/D) converter 220, a processor 222, and an optional input/output (I/O) interface 224.

The waveform generator 214 generates a reference signal to the intensity modulator 204 of the transmitter 104A and to the dechirper 216. The reference signal may comprise any waveform. Preferably, the reference signal is a chirping signal. The waveform generator 214 may receive instructions to select or set waveform parameters including the starting frequency of the reference signal, the pulse duration of the reference signal, the clock rate at which the signal is generated, and other parameters. Where the reference signal is a chirping signal, the waveform parameters may include the chirp rate and/or or a bandwidth. The chirp rate is equal to B/t. B is the bandwidth and is equal to f₂-f₁. f₁ is the first range of frequency, and f₂ is the second range of frequencies. Tau (t) is the time in which the chirping signal is generated at the bandwidth. The waveform parameters may be selected and changed to change the B and t of the f in the frequency/range equation to get the range (R) to fit through the filter 218.

As discussed below, the waveform generator 214 may be configured to generate multiple reference signals having different waveform parameters so that multiple optical carrier signals may be modulated differently based upon different expected ranges to targets or random range determination. Thus, the waveform generator 214 can generate waveforms with different waveform parameters, such as a first reference signal with a first B and t and a second reference signal with a second B and t so that the laser radar system 102A is sensitive to two different ranges.

In addition, the waveform generator 214 may be configured to generate the reference signal to the intensity modulator 204, delay for a delay period, and then transmit the reference signal to the dechirper 216. This process may be required when the range between the laser radar system 102A and the target is great, and a significant delay may occur between transmitting the transmit signal and receiving the receive signal. The dechirper 216 receives the RF envelope from the envelope detector 212 and the reference signal from the waveform generator 214. The dechirper correlates the RF envelope and the reference signal to generate a correlated signal. Since the RF envelope has an amplitude modulated reference signal portion, the reference signal is used by the dechirper 216 to generate a correlated signal. The correlated signal comprises the difference frequency between the RF envelope and the reference signal. Preferably, the dechirper 216 is a mixer that generates the sum frequency and the difference frequency between the RF envelope and the reference signal.

The filter 218 receives the correlated signal from the dechirper and filters the correlated signal. Preferably, the filter 218 is a low pass filter that enables the difference frequency in the correlated signal to pass to the A/D converter 220.

Because the expected frequency of the difference frequency is a function of the range from the laser radar system 102A to a target, the filter 218 must be selected based on an expected range to the target. Thus, if a long range is expected, a higher frequency filter may be selected. In one embodiment, a 12 MHz filter is used. It will be appreciated that if a first and second range are expected, the filter will be selected based upon the longer range.

In addition, the parameters selected for the waveform generator 214 and the parameters selected for the filter 218 operate in conjunction. Thus, the frequency of the filter 218 may be selected, and the parameters of the waveform generator 214 may be modified as needed for various expected ranges. Moreover, the parameters of the filter 218 may be selected, and multiple reference signals having different parameters may be generated from the waveform generator 214 to drive the intensity modulation of the optical carrier so that different ranges to one or more targets may be determined.

The A/D converter 220 receives the filtered difference frequency signal from the filter 218 and converts the signal to a digital signal. The A/D converter 220 has parameters that can be modified based upon satisfying the Nyquist rate requirements due to the selected frequency of the filter 218.

The processor 222 is any processor configured to process the digitized signal received from the AID converter 220. The processor 222 is configured to determine the range between the laser radar system 102A and the target. The processor 222 may process the digitized signal using the frequency/range equation identified above to determine the range. Other methods may be used.

The processor 222 may receive instructions and parameters for processing the digitized signal from the A/D converter 220. Processing parameters may include the number of samples to collect from the A/D converter 220, the type of averaging to use to process the digitized signals, the number of averages to process, and/or other parameters. For example, the processor 222 may be configured to process digitized signals using coherent averaging or incoherent averaging. With coherent averaging, the processor adds a first signal to a second signal and then uses the mean value of the added signals. Coherent averaging is used to eliminate noise components on the received signal. Incoherent averaging adds the magnitudes of a first signal and a second signal and uses the mean value of the added magnitudes. With incoherent averaging, the phase of the signals are not used. Incoherent averaging is used to reduce the variance of signals.

The processor 222 may output information for the range and/or other parameters, including the frequency and/or settable parameters via the I/O interface 220. The processor 222 may generate this information to a monitor, a printer, a media, or other devices.

The I/O interface 224 is configured to transmit information between the processor 222 and an external device. External devices may include a monitor, a printer, an optical media, a magnetic media, or any other device. The I/O interface 224 also is used to accept instructions and/or parameters from a device and transmit those instructions and/or parameters to the processor 222.

It will be appreciated that the laser radar system 102A of FIG. 2 may operate in other modes. For example, the laser radar system 102A may operate in a frequency modulation continuous wave (FM-CW) mode in which the transmitter is not turned off. Other operating modes may be used.

The laser radar system 102A of FIG. 2 operates as follows. In a first example, waveform parameters are set for the waveform generation 214. In this example, a chirp signal is to be sent as the reference signal and will have a starting frequency of 100 MHz, a chirp rate of 6.5 MHz, a pulse duration of 40 us, and a clock rate of 800 MHz. The waveform generator 214 generates the chirp signal to the intensity modulator 204 and to the dechirper 216. In this example, the filter 218 is a low pass filter having a 12 MHz pass filter, and the processor 222 is set to process digitized signals using incoherent averaging.

The laser 202 generates an optical carrier to the intensity modulator 204 and generates an optical local oscillator signal to the frequency shifter 106A. In this example, the laser 202 generates the optical carrier and the optical local oscillator signals at 1319 nm.

The intensity modulator 204 uses the chirping signal as the driver to amplitude modulate the optical carrier. In this example, the amplifier 206 is present in the system and amplifies the optical carrier. The amplifier 206 transmits the optical carrier to the optics 110 as a transmit signal, and the optics transmit the transmit signal from the laser radar system 102A.

The transmit signal makes contact with a target, and at least a portion of the transmit signal is reflected or otherwise scattered back to the laser radar system 102A as a receive signal. The optics 110 receive the receive signal and transmit the receive signal to the coherent detector 210.

In the interim, the frequency shifter 208 receives the optical local oscillator signal from the laser 202 and shifts the frequency of the optical local oscillator signal by 600 MHz. The frequency shifter 208 transmits the shifted optical local oscillator signal to the coherent detector 210.

The coherent detector 210 receives the receive signal and the shifted optical local oscillator signal. The coherent detector 210 mixes the receive signal with the shifted optical local oscillator signal to generate an RF carrier signal. In this example, the coherent detector 210 strips the optical carrier and replaces it with the RF carrier. The stripping of the optical carrier and the generation of the RF carrier is accomplished in the photodetector through a beating or mixing process.

The envelope detector 212 receives the RF carrier signal from the coherent detector 210 and strips the RF carrier to obtain an RF envelope. The envelope detector 212 transmits the RF envelope to the dechirper 216.

The dechirper 216 receives the RF envelope from the envelope detector 212 and receives the chirp signal from the waveform generator 214. The dechirper 216 beats the RF envelope with the chirp signal (i.e. mixes the two signals) to determine a correlated signal. The correlated signal is the result of the sum and difference frequencies when the chirp signal and the RF envelope are mixed. The dechirper 216 transmits the correlated signal to the filter 218.

The filter 218 filters the correlated signal with the low pass filter to obtain the lower frequency from the correlated signal. The filter 218 transmits the lower frequency signal to the A/D converter 220. The A/D converter 220 samples the analog frequency signal and converts it to a digitized signal. The A/D converter 220 transmits the digitized signal to the processor 222.

The processor 222 receives the digitized signal and uses signal processing to process the signal to obtain a frequency value of the samplings. The processor determines the range to the target by using the frequency/range equation of f=(2BR)/(ct) where “f” is the average frequency value equal to the frequency of the receive signal after it is applied to a frequency shifted optical local oscillator and subsequently dechirped and filtered. The processor 222 generates the range via the I/O interface 224 to a monitor.

It will be appreciated that multiple transmit signals may be generated and multiple receive signals may be received, and that a sampling of those digitized receive signals is used to perform the coherent averaging. Similarly, multiple transmit signals may be generated and multiple receive signals may be received and further processed for incoherent averaging. Thus, while the examples discuss a single transmit signal and a single receive signal, it will be appreciated that one transmit signal/receive signal or multiple transmit signals/receive signals may be generated and processed.

In another example, the waveform generator 214 and the processor 222 are configured to generate multiple transmit signals, each modulated with a different reference signal. In this example, three chirping signals, each having a different chirp rate, are transmitted to the intensity modulator 204 sequentially. In addition, the waveform generator 214 waits for a delay period prior to transmitting the same three chirping signals sequentially to the dechirper 216. In this example, the laser radar system 102A is used to locate an object of unknown range. Thus, the waveform parameters of the three chirping signals are selected with different chirping rates for detection of an object at short, medium, and long ranges.

The first, second, and third chirping signals are generated from the waveform generator 214 to the intensity modulator 204. Simultaneously, the laser 202 generates three optical carrier signals to the intensity modulator 204 and three local oscillator signals to the frequency shifter 208.

The intensity modulator 204 receives the first chirping signal and the first optical carrier signal, modulates the amplitude of a first optical carrier using the first chirping signal as the control, and transmits the first optical carrier signal to the optics 110 for transmission as a first transmit signal. In this example, the amplifier 206 is not required. Similarly, the laser generates a second optical carrier which is modulated in the intensity modulator 204 using the second chirping signal as a driver. The intensity modulator 204 transmits the second modulated optical carrier signal to the optics 110 for transmission as a second transmit signal. Similarly, the laser 202 transmits the third optical carrier to the intensity modulator 204 for modulation using the third chirping signal as a driver. The intensity modulator 204 transmits the third modulated optical carrier signal to the optics 110 as the third transmit signal. All three transmit signals sequentially are transmitted from the optics 110.

The first, second, and third transmit signals sequentially are scattered by a target, such that at least a portion of all three transmit signals are reflected back to the laser radar system 102A as receive signals. The first, second, and third receive signals are received by the optics 110 and transmitted to the coherent detector 210. The first, second, and third receive signals are processed by the coherent detector 210 and the envelope detector 212 as described above resulting in a first RF envelope, a second RF envelope, and a third RF envelope.

The first RF envelope is transmitted to the dechirper 216 and mixed with the first chirping signal to result in a first correlated signal. The second RF envelope is transmitted to the dechirper 216 and mixed with the second chirping signal to result in a second correlated signal. The third RF envelope is transmitted to the dechirper 216 and mixed with the third chirping signal to result in a third correlated signal. The first, second, and third correlated signals are transmitted to the filter 218 for filtering with a low pass filter.

The filter 218 filters all three correlated signals. Since the filter 218 has a specific low pass filter in this example, the first correlated signal is processed by the low pass filter, and the difference frequency of the first correlated signal is passed to the AID converter 220. However, in this example the sum and difference frequencies of the second and third correlated signals do not pass through the filter 218 because their frequencies are higher than the frequency of the low pass filter. Therefore, their difference frequencies are not passed to the AID converter 220.

The A/D converter 220 processes the difference frequency from the first correlated signal using the samplings identified by the processor 222. The A/D converter 220 digitizes the analog difference frequency from the first correlated signal and transmits the digitized signal to the processor 222. The processor 222 processes the digitized signal frequency to determine the range to the object. In this example, the range to the object was within a short range. In this example, the parameters of the first chirping signal were set to locate an object within a short range, the parameters of the second chirping signal were set to locate an object within a medium range, and the parameters of the third chirping signal were set to locate an object within a longer range.

In another example, the waveform generator 214 generates a chirp waveform to the intensity modulator 204. Additionally, the waveform generator 214 transmits the chirp waveform to the dechirper 216. Concurrently, the laser 202 transmits the optical carrier to the intensity modulator 204 and the local oscillator signal to the frequency shifter 208.

The optical carrier is modulated by the chirp signal with a bandwidth commensurate with the desired range and accuracy. Thus, the chirp waveform is used as the modulation signal in the intensity modulator 204. The chirp waveform consists of a sinusoid whose frequency varies linearly from f₁ to f₂, where f₂-f₁ is the signal bandwidth (B). In this example, f₁ is 100 MHz, f₂ is 360 MHz, and B is 260 MHz. The chirp waveform is produced in the waveform generator 214 digitally using direct digital synthesis (DDS).

As stated, the chirp signal is used to drive the intensity modulator 204 to amplitude modulate the optical carrier. The optical carrier then is transmitted to the optics 110 and generated from the optics as a transmit signal. When the receive signal (the received optical signal) is received at the optics 110, it is transmitted to the coherent detector 210.

Currently, the local oscillator signal is frequency shifted in the frequency shifter 208. The frequency shifter 208 transmits the local oscillator signal to the coherent detector 210.

The coherent detector 210 receives the local oscillator signal and the receive signal and processes the two signals. The coherent detector 210 generates therefrom an RF carrier that is amplitude modulated by the chirp waveform. The RF carrier signal then is detected by an envelope detector 212, where the chirp waveform is recovered.

The envelope detector 212 recovers the RF envelope, and the carrier signal is rejected. By using envelope detection, the optical phase information is discarded, thus avoiding any temporal correlation issues commonly associated with coherent laser remote sensing. These correlation issues may include laser phase noise, atmosphere disturbance, and frequency shifting due to doppler effects.

Once the RF envelope is retrieved in the envelope detector 212, the RF envelope is dechirped in the dechirper 216 using the original RF chirp waveform generated from the waveform generator 214. The signal output from the dechirper 216 is a sinusoid of duration “t” and frequency “f” where f=(2BR)/(ct). This frequency signal is filtered in the filter 218, digitized in the A/D converter 220, and transmitted to the processor 222. Prior to the frequency analysis, digitized samples of previous signals may be averaged together to suppress the noise while preserving the signal. By averaging N echoes, coherent integration processes provide an improvement to the SNR by a factor of N.

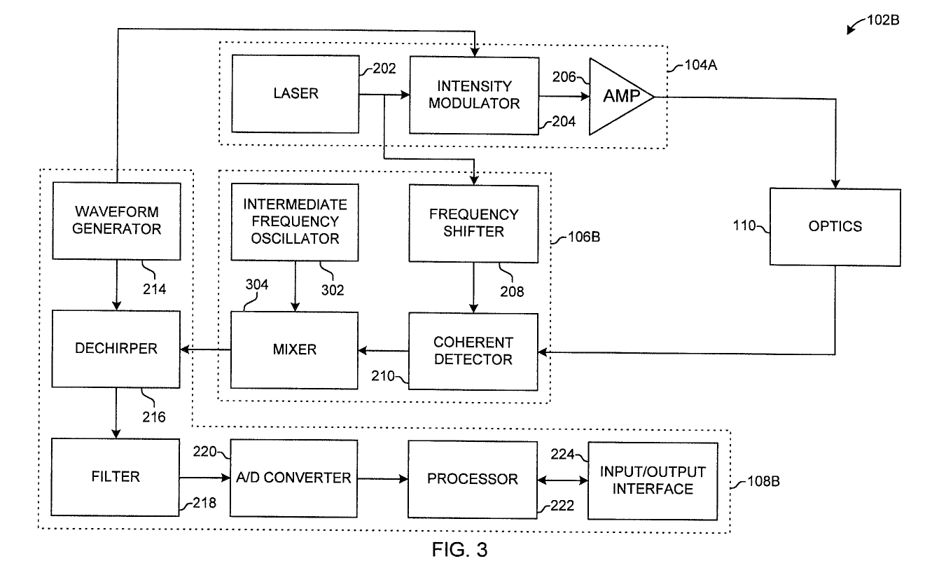

FIG. 3 depicts an exemplary embodiment of a laser radar system 102B in which the receiver 108B uses an intermediate frequency oscillator 302 and a mixer 304 in place of an envelope detector. The laser radar system 102B of FIG. 3 provides a receiver that is truly linear. Thus, the receiver 108B may be more efficient than a non-truly linear system. In this example, the received signal has an optical phase and doppler shift when it is mixed by the mixer 304.

The intermediate frequency oscillator 302 generates a radio frequency local oscillator signal having an intermediate frequency. The intermediate frequency oscillator 302 transmits the RF LO signal to the mixer 304. The intermediate frequency oscillator 302 generates a signal that has been frequency shifted locally as an intermediate step in transmission.

The mixer 304 receives the RF LO signal from the intermediate frequency oscillator 302 and receives the RF carrier signal from the coherent detector 210. The mixer 304 mixes the two signals to eliminate the RF carrier component so that RF envelope is left.

The intermediate frequency oscillator 302 generates a waveform that ramps up and down instead of just up. Thus, the dechirper 216 mixes a signal for an upchirp and downchirp. The two then are averaged in the processor 222.

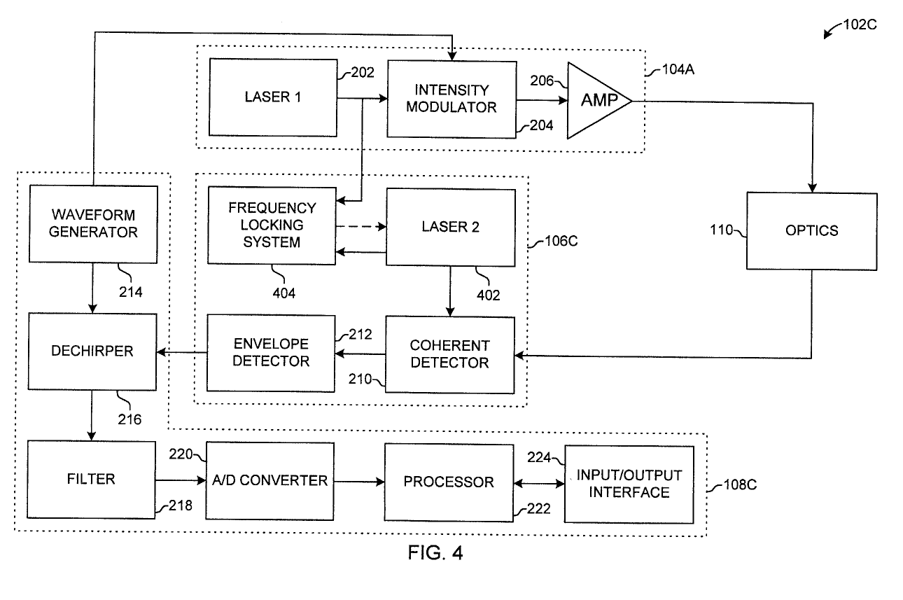

FIG. 4 depicts an exemplary embodiment of a laser radar system 102C having a feedback signal. The laser radar system 102C of FIG. 4 does not have a frequency shifter. However, the laser radar system 102C of FIG. 4 comprises a second laser 402 and a frequency locking system 404.

The second laser 402 generates an optical signal having a frequency shifted from the frequency of the optical carrier generated by the laser 202. The second laser 402 generates the optical signal with the shifted frequency to the coherent detector 210 as an optical local oscillator signal and to the frequency locking system 404 as an optical carrier.

The frequency locking system 404 receives the first optical carrier from the first laser 202 and the second optical carrier from the second laser 404. The frequency locking system 404 is used to maintain the difference in frequencies for the optical carriers generated by the first laser 202 and the second laser 402. Thus, the frequency locking system 404 maintains a constant frequency difference between the optical carriers of the two lasers 202 and 402. The frequency locking system 404 generates a feedback signal to the second laser 404 to correct for any deviation from the frequency difference. The feedback signal may be a voltage or current that drives a bias voltage or current in the second laser 402. In one embodiment, the wavelength of the optical carrier generated by the second laser 402 is shifted by 600 MHz from the wavelength of the optical carrier generated by the first laser 202.

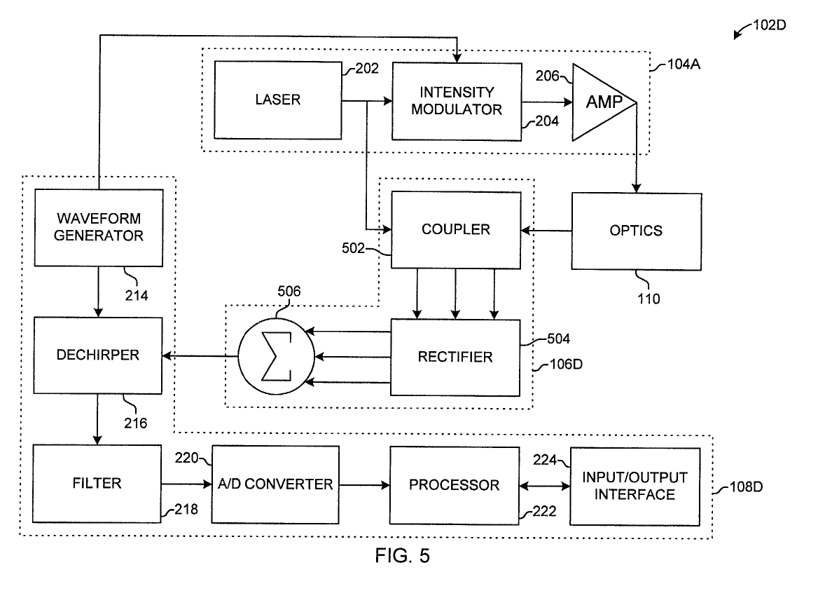

FIG. 5 depicts an exemplary embodiment of a laser radar system 102D having a homodyne configuration. The receiver 106D of FIG. 5 comprises a coupler 502, a rectifier 504, and a power combiner 506.

The coupler 502 couples the receive signal with the optical local oscillator signal to generate multiple signals with a variant in the phases of each signal. Preferably, the coupler 502 is a 3x3 coupler, thus having three inputs or three outputs. The coupler 502 receives the receive signal at one input and the optical local oscillator signal at a second input. The third input is not used. The coupler 502 generates receive signals having phase diversity. Thus, the coupler 502 generates a first receive signal having a first phase, a second receive signal having a second phase, and a third receive signal having a third phase. Preferably, the phases are 0°, 120°, and 240°. Each of the signals are transmitted to the rectifier 504.

The rectifier 504 passes to the envelope detector 212A a fixed frequency response as the phase diversity signal. Typically, the fixed frequency is an upper frequency limit. Therefore, the rectifier 504 also may be used as a filter. Preferably, the rectifier 504 are photo diodes.

The power combiner 506 combines each of the RF envelopes received from the envelope detector 212A to form a composite signal. Preferably, the power combiner provides a summation. The power combiner 506 transmits the composite signal to the dechirper 216. It will be appreciated that a band pass filter may be placed between the rectifier 504 and the envelope detector 212A.

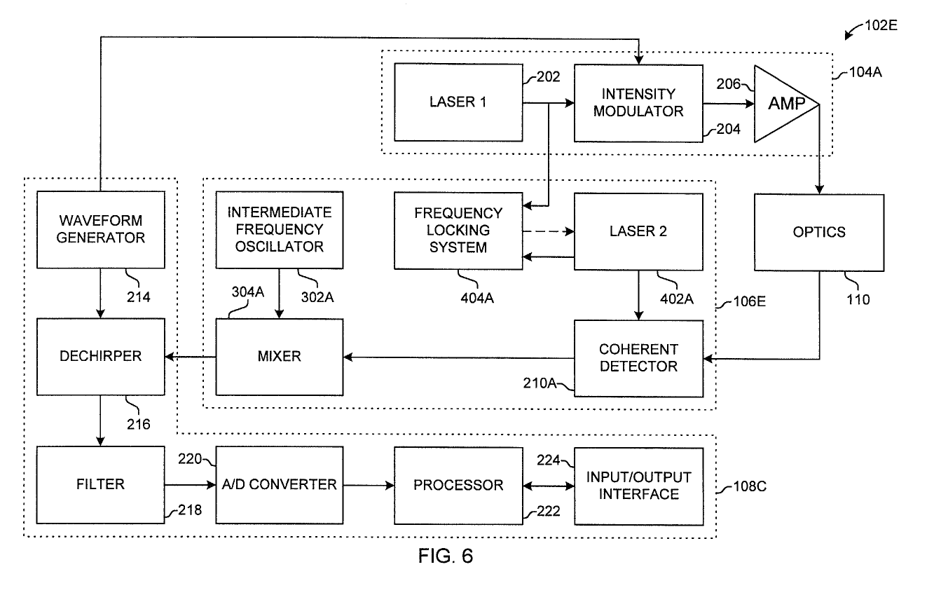

FIG. 6 depicts an exemplary embodiment of a frequency locking system with feedback to a second laser creating a conjunction with an intermediate frequency oscillator and mixer. The receiver 106E of FIG. 6 comprises a second laser 402A operating as a local oscillator signal to a coherent detector 210A. The local oscillator signal generated by the second laser 402A has a frequency shift over the optical carrier signal generated from the first laser 202 to the intensity modulator 204. The frequency locking system 404A maintains the frequency difference between the first laser 202 and the second laser 402A by receiving the optical carrier signal from the first laser and the local oscillator signal from the second laser in generating a feedback signal to the second laser. The feedback signal identifies any additional shift in the local oscillator signal that must be made to maintain the frequency shift between the optical carrier signal of the first laser 202 and the local oscillator signal of the second laser 402A.

The intermediate frequency oscillator 302A and the mixer 304A of the receiver 106E operate the same as the intermediate frequency oscillator 302 and mixer 304 of FIG. 3. Moreover, the coherent detector 210A operates the same as the coherent detector 210 of FIG. 3.

Those skilled in the art will appreciate that variations from the specific embodiments disclosed above are contemplated by the invention. The invention should not be restricted to the above embodiments, but should be measured by the following claims.

What is claimed is:

1. A system for determining a range to an object using laser radar comprising:
a controller configured to generate a first reference signal;
a transmitter configured to generate an optical carrier, to use the first reference signal to amplitude modulate the optical carrier to create a transmit signal, and to generate an optical local oscillator signal;
optics configured to transmit the transmit signal and to receive a receive signal, the receive signal being at least a portion of the transmit signal scattered back to the receiver; and
a receiver configured to receive the receive signal and to process the receive signal with the optical local oscillator signal to generate an RF envelope;
wherein the controller further is configured to process the RF envelope with a second reference signal to determine a difference frequency between the RF envelope and the second reference signal.
